(19) United States
(12) Patent Application Publication
(10) Pub. No.: US 2003/0157934 A1
(43) Pub. Date: Aug. 21, 2003

(54) Method, system, device and computer program product for bandwidth utilization and signal strength-based handover initiation in a wireless communications network

(76) Inventor: Qilian Liang, San Diago, CA (US)

Correspondence Address: Hughes Electronics Corporation, Patent Docket Administration, Bldg. 1, Mail Stop A109, P.O. Box 956, El Segundo, CA, 90245-0956, US

(21) Appl. No.: 10/061,644

(22) Filed: Feb. 1, 2002

(51) Int. Cl. H04Q 7/20

(52) U.S. Cl. 455/436; 455/437

(57) ABSTRACT

A method, system, device and computer program product for bandwidth utilization and signal strength-based handover initiation in a wireless communications network, including determining signal strengths received at a mobile wireless device from a present and a target base station; determining bandwidth utilizations at the present and the target base stations; and performing handover initiation of the mobile device based on the determined signal strengths and the determined bandwidth utilizations.

### BACKGROUND OF THE INVENTION

1. Field of the Invention

The present invention generally relates to wireless communications systems and more particularly to a method, system, device and computer program product for bandwidth utilization and signal strength-based handover initiation in a wireless communications network, such as a mobile cellular communications network, a mobile satellite communications network, a mobile wireless local area network (LAN), etc. The present invention includes use of various technologies described in the references identified in the appended LIST OF REFERENCES and cross-referenced throughout the specification by numerals in brackets corresponding to the respective references, the entire contents of all of which are incorporated herein by reference.

2. Discussion of the Background

In recent years, wireless communications systems, such as a mobile cellular communications network, a mobile satellite communications network, a mobile wireless local area network (LAN), etc., have been designed to employ a set of traffic control and network management functions. Such functions typically are provided by such systems in order to ensure a Quality of Service (QoS) level for a given type of multimedia service (audio, video, audio on-demand, video on-demand, wireless telephony functions, etc.) and so as to achieve a high level of network utilization.

In such systems, a handover mechanism is employed to transfer an ongoing call or connection from one cell to another cell as a user moves through a coverage area of a system, such as a cellular system, etc. Minimizing a number of handovers minimizes switching load and delay, which minimizes co-channel interferences [13].

Accordingly, a good handover algorithm should minimize a number of handovers and delay, while maintaining a desirable QoS level. In such systems, a handover procedure is usually split into an initiation phase and an execution phase. The former refers to the efficient processing of radio link quality measurements and the latter refers to the efficient management of radio resources [4].

A popular handover initiation algorithm is referred to as the “relative signal strength with hysteresis” [16] [17] method, which makes a handover decision typically based on just signal strengths. However, a wide range of service characteristics related to handover, such as handover blocking probability, call dropping probability, probability of an unnecessary handover, duration of interruption and handover delay, time-sensitivity of services (e.g., voice or media data), etc., typically makes the use of such a traditional control method very difficult to employ. In addition, it is a daunting task to derive a mathematical model for use in such method.

Therefore, there is need for a method, system, device and computer program product for handover initiation that is more robust than handover initiation based on just signal strengths and that does not employ complex mathematical models.

### SUMMARY OF THE INVENTION

The above and other needs are addressed by the present invention, which provides an improved method, system, device and computer program product for bandwidth utilization and signal strength-based handover initiation and which is more robust than handover initiation based on just signal strengths and which does not employ complex mathematical models.

Accordingly, in one aspect of the present invention there is provided an improved method, system, device and computer program product for bandwidth utilization and signal strength-based handover initiation in a wireless communications network, including determining signal strengths received at a mobile wireless device from a present and a target base station; determining bandwidth utilizations at the present and the target base stations; and performing handover initiation of the mobile device based on the determined signal strengths and the determined bandwidth utilizations.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1(a)-1(c) are top level system diagrams illustrating exemplary wireless communications systems, which may employ bandwidth utilization and signal strength-based handover initiation, according to the present invention;

FIG. 2 is a block diagram illustrating a bandwidth utilization and signal strength-based handover initiation device, which may be employed in the systems of FIGS. 1(a)-1(c), according to the present invention;

FIG. 3 is a block diagram of a fuzzy logic system (FLS) used in the handover initiation device of FIG. 2, according to the present invention;

FIG. 4 is a graph illustrating membership functions (MFs) used to represent three linguistic labels in the FLS of FIG. 3, according to the present invention;

FIGS. 5(a) and 5(b) are graphs illustrating a handover possibility y(x₁, x₂, x₃, x₄), versus x₁ (i.e., bandwidth utilization (x₁) of a current base station (BS1)) and x₂ (i.e., bandwidth utilization (x₂) of a target base station (BS2)), when (a) signal strengths x₃=3 of BS1 and x₄=6 of BS2 and (b) x₃=6 of BS1 and x₄=3 of BS2, according to the present invention;

FIGS. 6(a) and 6(b) are graphs illustrating a decision boundary generated by the FLS of FIG. 3 based on (a) signal strengths x₃=3 of BS1 and x₄=6 of BS2 and (b) x₃=6 of BS1 and x₄=3 of BS1, according to the present invention;

FIG. 7 is a flow chart illustrating the operation of the bandwidth utilization and strength-based handover initiation, according to the present invention; and

FIG. 8 is an exemplary computer system, which may be programmed to perform one or more of the processes of the present invention.

### DETAILED DESCRIPTION OF THE PREFERRED EMBODIMENTS

A method, system, device and computer program product for bandwidth utilization and signal strength-based handover initiation, are described. In the following description, for purposes of explanation, numerous specific details are set forth in order to provide a thorough understanding of the present invention. It is apparent to one skilled in the art, however, that the present invention may be practiced without these specific details or with an equivalent arrangement. In some instances, well-known structures and devices are shown in block diagram form in order to avoid unnecessarily obscuring the present invention.

Generally, the present invention uses a fuzzy logic system (FLS) [9] with rules for bandwidth utilization and signal strength-based handover initiation determined based on the experience of a group of network experts. A rule-based FLS is computed and a decision surface for soft handover is determined. Hard decisions then are made, for example, based on a quality of service (QoS) [19] and a multimedia category.

The present invention includes recognition that intelligent techniques may be applied to handover initiation. For example, special issues on intelligent techniques in high speed networks have been published by IEEE Journal on Selected Areas in Communications (see, e.g., [2] [3]). According to [3], “The advantages of intelligent techniques are numerous, most notably are learning from experience, . . . ”. Recently, Liang and Mendel [6] applied fuzzy logic systems to connection admission control in Asynchronous Transfer Mode (ATM) [18] networks; and Shum and Sung [15] applied fuzzy layer selection method to microcell and macrocell determination after a handover request is initiated. These approaches simplify such problems tremendously.

The present invention, however, uses a fuzzy logic system (FLS) for making handover initiation soft decisions based on signal strength and bandwidth utilization considerations. Fuzzy logic systems represent and numerically manipulate linguistic rules in a natural way and handle problems that conventional control theory typically cannot approach successfully. This is because conventional control theory typically relies on a valid and accurate model, which does not always exist.

The fuzzy logic handover initiation system of the present invention is based on, for example, rules collected by surveying a group of experts and the expertise of such experts in handover scenarios for various values of signal strength and bandwidth utilization. In contrast, most existing handover initiation algorithms assume that there is sufficient bandwidth to accommodate a handover, which always is not the case. With such algorithms, a handover call may be blocked, if there is no free channel in the new cell. Since blocking a handover call is much worse than blocking a new call, lots of schemes have been developed to prioritize handover calls, e.g., a channel reservation scheme [12], a queuing scheme [14], etc.

The present invention, however, uses a scheme that takes bandwidth utilization and signal strength into consideration in a handover initiation decision so as to minimize a possibility of blocking a handover. In [5], a channel carrying scheme is proposed, wherein a channel is carried into a new cell and is used to communicate with a base station (BS) in the new cell. Such a scheme, however, may cause undesirable co-channel interference. In contrast, according to present invention, a mobile user terminal (e.g., a mobile cellular communications device, a mobile satellite communications device, a mobile wireless local area network (LAN) device, etc.) may continue to use a current channel in a new cell and communicate with the BS in an old cell (i.e., without handover), because a handover may be blocked based on signal strength and bandwidth utilization considerations, while meeting a QoS level.

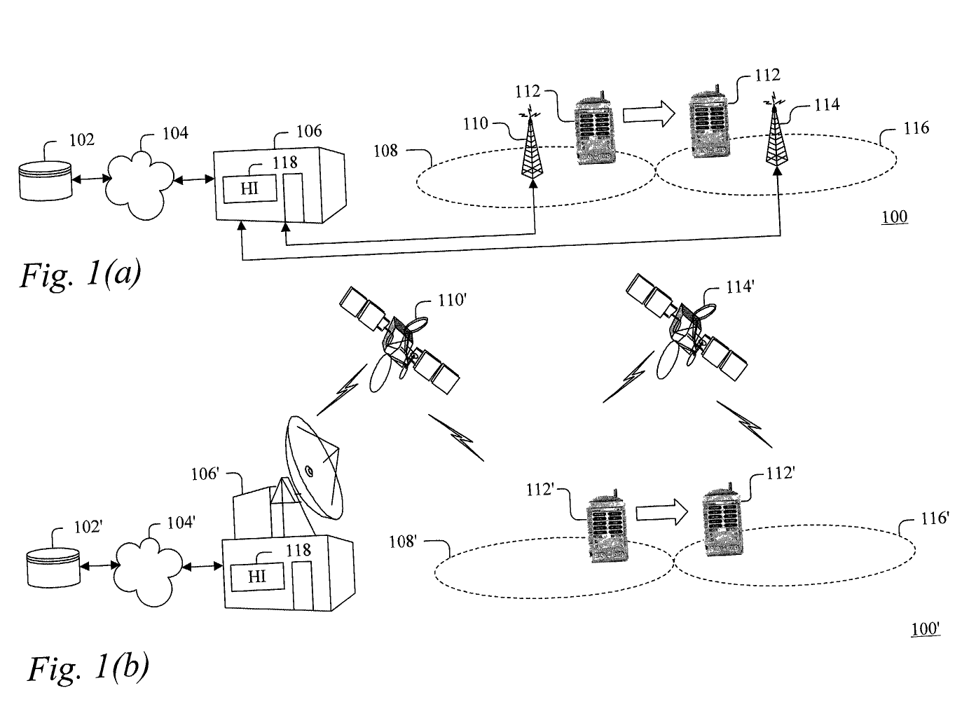

Referring now to the drawings, wherein like reference numerals designate identical or corresponding parts throughout the several views, and more particularly to FIGS. 1(a)-1(c) thereof, there are illustrated exemplary wireless communications systems, in which bandwidth utilization and signal strength-based handover initiation according to the present invention may be employed. FIG. 1(a) illustrates an exemplary cellular communications [21] system 100 including bandwidth utilization and signal strength-based handover initiation logic 118 (e.g., implemented via hardware and/or software devices) according to the present invention.

In FIG. 1a, the cellular communications system 100 includes one or more data sources 102 (e.g., video, audio, streaming video, streaming audio, Web server content, telephony, etc.) coupled via a communications network 104 (e.g., a Public Switched Telephone Network (PSTN), etc.) to a mobile telephone switching office (MTSO) [22] 106. The bandwidth utilization and signal strength-based handover initiation logic 118 according to the present invention may be included in the MTSO 106.

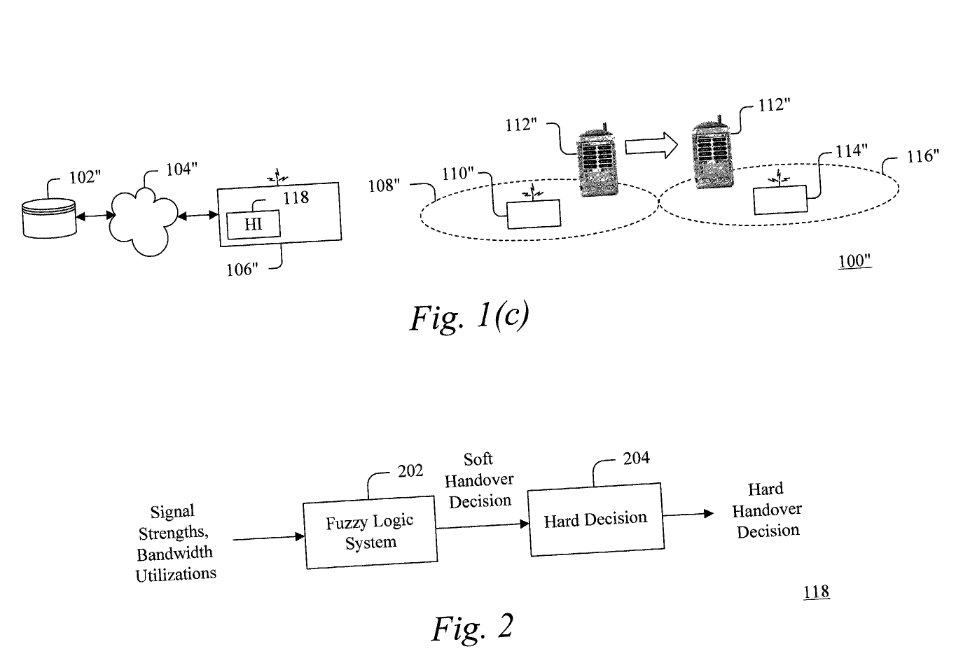

The MTSO is coupled to one or more cell site antenna systems or base stations (BSs) 112 and 114. The cell site antenna systems 110 and 114 define corresponding cell coverage areas or cells 108 and 116. As a mobile unit 112 (e.g., cellular phone, hand-held wireless device, etc.) travels from the cell 108 to the cell 116, the bandwidth utilization and signal strength-based handover initiation logic 118 in the MTSO 106 performs handover initiation, as is farther described in detail with respect to FIGS. 2-7.

FIG. 1(b) illustrates an exemplary satellite communications system 100′ including the bandwidth utilization and signal strength-based handover initiation logic 118 according to the present invention. The satellite communications system 100′ of FIG. 1(b) operates in a similar manner as the cellular communications system 100 of FIG. 1(a), with the cell site antenna systems or base stations 110 and 114 corresponding to satellites 110′ and 114′, the MTSO 106 corresponding to a network operations control center 106′, the cells 108 and 116 corresponding to satellite coverage areas 108′ and 116′, etc. Further description of the system of FIG. 1(b) is omitted here for the sake of brevity.

FIG. 1(c) illustrates an exemplary wireless local area network (LAN) system 100″ including the bandwidth utilization and signal strength-based handover initiation logic 118 according to the present invention. The wireless LAN system 100″ of FIG. 1(c) operates in a similar manner as the cellular communications system 100 of FIG. 1(a), with the cell site antenna systems or base stations 110 and 114 corresponding to wireless network access points (e.g., model WAP11 from Linksys) 110″ and 114″, the MTSO 106 corresponding to a wireless network access point and cable/DSL router (e.g., model BEFW11S4 from Linksys) 106″, the cells 108 and 116 corresponding to satellite coverage areas 108′ and 116′, the mobile unit 112 corresponding to, for example, a laptop personal computer (PC) with a wireless network PC card (e.g., model WPC11 from Linksys) 112″, etc. Further description of the system of FIG. 1(c) is omitted here for the sake of brevity.

With the above-noted systems 100-100″, video download, audio download, graphics download, file download, pay per view, video-on-demand, audio-on-demand, Internet surfing, e-mail, voice communications, text communications, paging functions, telephony functions, etc., may be implemented on the devices 112-112″. One or more interface mechanisms may be used in the systems 100-100″, for example, including Internet access, telecommunications in any form (e.g., voice, modem, etc.), wireless communications media, etc., via the communication networks 104-104″ and the base stations 110-110″ and 114-114″. Information used in the systems 100-100″ also may be transmitted via direct mail, hard copy, telephony, etc., when appropriate.

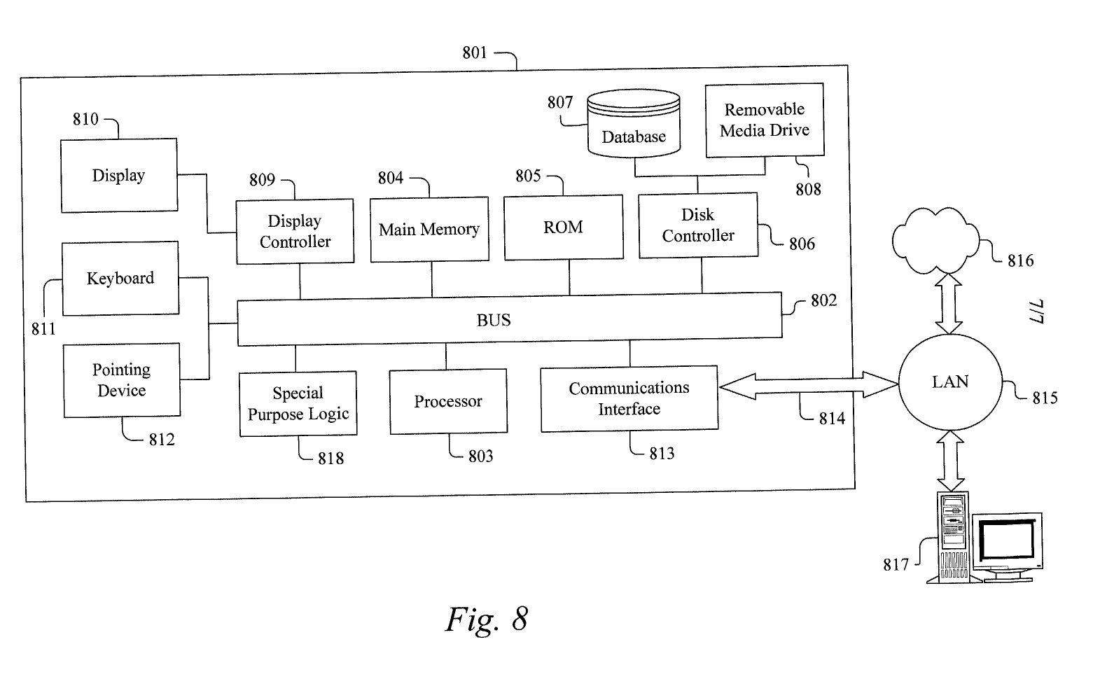

Accordingly, the devices 102-102″, 118-118″, 110-110″, 114-114″ and 112-112″ of the systems 100-100″ may include any suitable servers, workstations, personal computers (PCs), laptop PCs, personal digital assistants (PDAs), Internet appliances, set top boxes, wireless devices, cellular devices, satellite devices, other devices, etc., capable of performing the processes of the present invention. The devices 102-102″, 118-118″, 110-110″, 114-114″ and 112-112″ of the systems 100-100″ may communicate with each other using any suitable protocol and, for example, via the communications networks 104-104″ and the base stations 110-110″ and 114-114″ and may be implemented using the computer system 801 of FIG. 8, for example.

It is to be understood that the devices in the systems 100-100″ of FIGS. 1(a)-1(c) are for exemplary purposes only, as many variations of the specific hardware used to implement the present invention are possible, as will be appreciated by those skilled in the relevant art(s). For example, the functionality of the one or more of the devices 102-102″, 118-118″, 110-110″, 114-114″ and 112-112″ may be implemented via one or more programmed computers or devices. On the other hand, two or more programmed computers or devices, for example as in shown FIG. 8, may be substituted for any one of the devices 102-102″, 118-118″, 110-110″, 114-114″ and 112-112″. Principles and advantages of distributed processing, such as redundancy, replication, etc., may also be implemented as desired to increase the robustness and performance of the systems 100-100″ of FIGS. 1(a)-1(c), for example.

The communications networks 104-104″ may be implemented via one or more communications networks (e.g., the Internet, an Intranet, a wireless communications network, a satellite communications network, a cellular communications network, a hybrid network, etc.), as will be appreciated by those skilled in the relevant art(s). In a preferred embodiment of the present invention, the communications networks 104-104″ and the devices 102-102″, 118-118″, 110-110″, 114-114″ and 112-112″ preferably use electrical signals, electromagnetic signals, optical signals, etc., that carry digital data streams, as are further described with respect to FIG. 8.

FIG. 2 is a block diagram illustrating the bandwidth utilization and signal strength-based handover initiation device 118 of the systems 100-100″ of FIGS. 1(a)-1(c), according to the present invention. In FIG. 2, the device 118 includes a fuzzy logic system (FLS) 202 (e.g., implemented via hardware and/or software) coupled to hard decision logic 204 (e.g., implemented via hardware and/or software). The FLS 202 receives, as a crisp input, signal strengths at the devices 112-112″ from the cells 108-108″ and 116-116″ and bandwidth utilizations in the cells 108-108″ and 116-116″ from the control centers 106-106″.

The FLS 202 then generates a handover initiation soft decision, as a crisp output thereof, based on the received crisp input. The hard decision logic 204 then generates a handover initiation hard decision based on the handover initiation soft decision received from the FLS 202. The control centers 106-106″ then perform handover initiation based on the handover initiation hard decision received from the hard decision logic 204. The bandwidth utilization and signal strength-based handover initiation according to the present invention will now be described in detail in the following sections and with reference to FIGS. 1-8.

Overview of Fuzzy Logic Systems

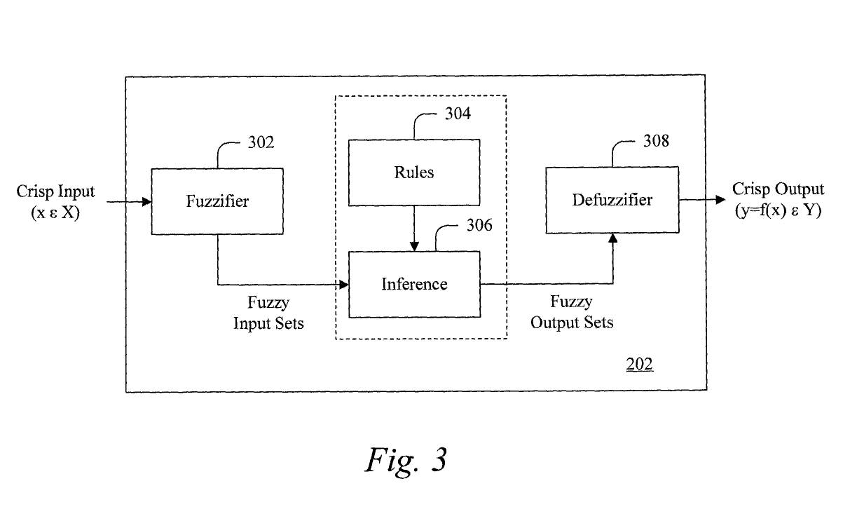

FIG. 3 illustrates a structure of the FLS 202. When an input is applied to the FLS 202, an inference engine 306 computes an output set corresponding to each rule of the rule sets 304. A defuzzifer 308 then computes a crisp output from the rule sets 304. For example, consider a p-input 1-output FLS 202, using singleton fuzzification in a fuzzifier 302, “center-of-sets” defuzzification [11] in the defuzzifer 308 and “IF-THEN” rules in the rule sets 304 of the form [7]:

R^{l}:IF x₁ is F^{l}₁ and x₂ is F^{l}₂ and . . . and xₚ is F^{l}ₚ, THEN y is G^{l}.

Assuming the singleton fuzzification in the fuzzifier 302, when an input x′={x₁′, . . . , xₚ′} is applied, a degree of firing corresponding to an lth rule is computed as:

$${μ}_{F1}^{l} ( {x}_{1}^{′} ) * {μ}_{F2}^{l} ( {x}_{2}^{′} ) * … * {μ}_{Fp}^{′} ( {x}_{p}^{′} ) = {T}_{i = 1}^{p} {μ}_{Fi}^{l} ( {x}_{i}^{′} ) \qquad ( 1 )$$

(1) where * and T both indicate a chosen t-norm. There are many kinds of defuzzification algorithms that may be employed in the defuzzifer 308. In the present invention, for illustrative purposes, the defuzzifier 308 is based on the center-of-sets defuzzifier [11]. The defuzzifier 308 computes a crisp output for the FLS 202 by first computing a centroid, c_{G}^{l}, of every consequent set G^{l}, and, then computing a weighted average of such centroids. The weight corresponding to the lth rule consequent centroid is the degree of firing associated with the lth rule, T^{p}ᵢ₌ₗμ^{l}_{F}ᵢ(xᵢ′), so that:

$${y}_{cos} ( {x}^{′} ) = \frac{{\sum }_{l = 1}^{M} {c}_{G}^{l} {T}_{i = 1}^{p} {μ}_{Fi}^{l} ( {x}_{i}^{′} )}{{\sum }_{l = 1}^{M} {T}_{i = 1}^{p} {μ}_{Fi}^{l} ( {x}_{i}^{′} )} \qquad ( 2 )$$

where M is the number of rules set 304 in the FLS 202.

In the present invention, the FLS 202 for handover initiation is designed with the rules set 304 determined based on the knowledge gleaned from a group of network experts.

Extracting the Knowledge for Handover

Generally, handover initiation criteria are based on (i) a length and shape of an averaging window, (ii) a threshold level and (iii) a hysteresis margin. Detailed studies have been done to determine the shape and the length of the averaging window. In the present invention, soft threshold level and hysteresis margins are determined rather than employing fixed ones. The present invention considers bandwidth utilization in addition to averaged signal strength (referred to as “signal strength”) in the handover initiation. This becomes especially important when the cells 108-108″ and 116-116″ are not uniformly loaded. Hence, four descriptors are used in the present invention, the current base station 108-118″ (BS1) signal level (x₃), the target base station 116-116″ (BS2) signal level (x₄), the bandwidth utilization of cell1 ((x₁), i.e., cell 108-108″, where BS1 is located) and the bandwidth utilization of cell2 ((x₂), i.e., cell 116-116″, where BS2 located). The linguistic variables used to represent the bandwidth utilization and signal strengths, for example, are divided into three levels: low, moderate and high. The consequent (i.e., the possibility of handover) is also expressed with the same three levels.

In one embodiment, questions were designed using an intersection rule configuration (IRC)-based structure (e.g., most FLSs are based on such structure), such as:

IF the bandwidth utilization of cell1 is moderate and the bandwidth utilization of cell2 is high and the signal level of BS1 is low and the signal level of BS2 is moderate THEN the possibility of handover is ______.

It was then discovered that 3⁴=81 rules for the FLS 202 would be employed because every antecedent has 3 fuzzy sub-sets and there are 4 antecedents. In addition, it was noticed that it was very difficult for an expert to finish such a question having 4 antecedents. Accordingly, in the preferred embodiment, each 4 antecedent rule is split in to two rules each having 2 antecedents. For example, the above rule was split into two rules, as follows:

IF the bandwidth utilization of cell1 is moderate and the bandwidth utilization of cell2 is high THEN the possibility of handover is ______.

or

IF the signal level of BS1 is low and the signal level of BS2 is moderate THEN the possibility of handover is ______.

This kind of rule structure is called union rule configuration (URC)-based rule structure, which was recently proposed by Combs and Andrews [1]. The URC-based structure can tremendously reduce the number of rules as compared to the IRC-based structure. In this way, only 3²+3²=18 rules were employed in the rules set 304 in the preferred embodiment because every antecedent has 3 fuzzy sub-sets and there are 2 antecedents. In addition, the new questions employing only two antecedents were much easier to answer.

The present invention uses rules obtained from the knowledge of many network experts (e.g., 20 system/network engineers). These experts were requested to choose a consequent using one of the three linguistic variables. Different experts gave different answers to the questions in the survey. As pointed out in [10], “words mean different things to different people” and in [8], “the decision makers may have the same preferences to a particular alternative, e.g., highly preferred but with different degrees;” so, two different kinds of surveys were created for the network experts. The first survey asked the experts to locate each linguistic label in the interval [0, 10] domain. The three labels were randomized, as shown in Table 1, so that they are uncorrelated.

TABLE 1
Survey table: randomized labels.

| | | |
|---|---|---|
| Linguistic label | Start | End |

low
moderate
high

For each linguistic label, 20 intervals were obtained from the 20 experts and the mean and standard deviation (std) of the two end-points of each label were then computed. The survey results are summarizes in Table 2.

TABLE 2
Processed survey results: ordered labels.

| | |
|---|---|
| Means | Standard Deviations |

| No. | Range Label | Start (a) | End (b) | Start (σₐ) | End (σ_{b}) |
|---|---|---|---|---|---|
| 1 | low | 0 | 3.579 | 0 | 1.217 |
| 2 | moderate | 3.025 | 7.326 | 1.2743 | 1.321 |
| 3 | high | 6.734 | 10 | 1.1468 | 0 |

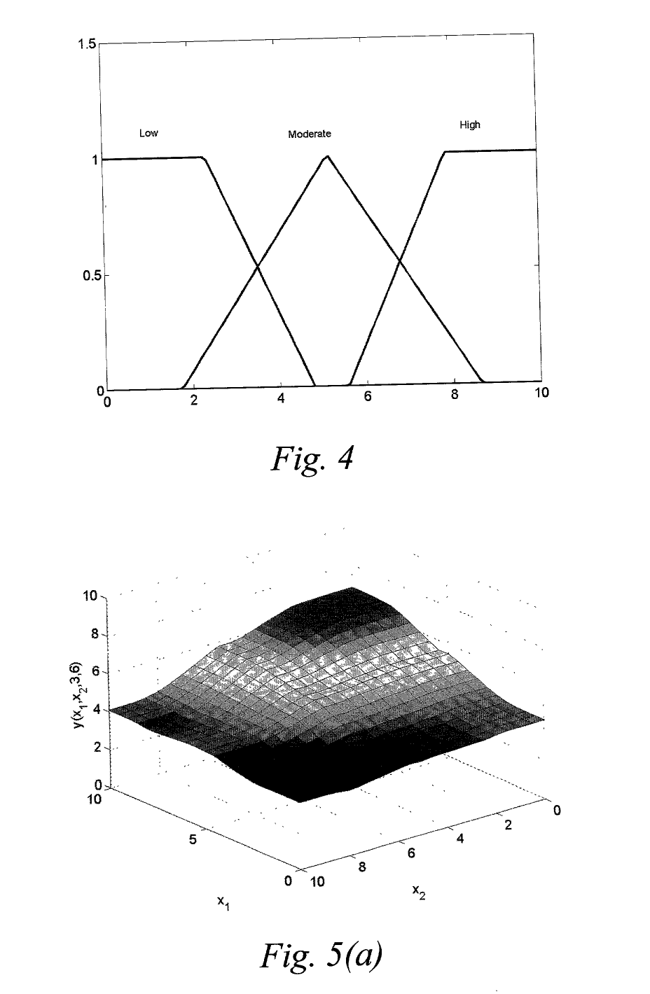

Then, based on the survey results, trapezoidal membership functions (MFs) were employed to represent the “low” and “high” labels and triangular MFs were employed to represent the “moderate” label. For the linguistic label “moderate,” the mean values of interval end-points thereof are a and b, the standard deviation (std) of the left end-point thereof is σₐ and the std of the right end-point thereof is σ_{b}. The three break points of the triangular MFs were then located at (a−σₐ, 0), ((a+b)/2, 1), and (b+σ_{b}, 0). For the linguistic labels “low” and “high”, the four break points in the trapezoidal MFs thereof were located at (a−σₐ, 0), (a, 1), (b−σ_{b}, 1), and (b+σ_{b}, 0). The MFs are illustrated in FIG. 4.

The second survey is a handover technical survey, as described previously. Tables 3 and 4 below summarize the questions used in this survey. The questions were randomized in the actual survey, but are shown in their natural order for convenience.

In Table 3, Antecedent 1 is the bandwidth utilization (x¹) of current cell (cell1), Antecedent 2 is the bandwidth utilization (x₂)of target cell (cell2) and Consequent is the possibility of handover (from BS1 to BS2). The experts were asked to fill in the blank for the Consequent using one of three linguistic labels (low, moderate, and high). The experts were given a randomized version of the nine questions shown in Table 3.

TABLE 3
Questions for handover in mobile multimedia cellular networks.

| Question | bandwidth utilization | bandwidth utilization | possibility of |
|---|---|---|---|
| # | of cell1 | of cell2 | handover |
| 1 | low | low | |
| 2 | low | moderate | |
| 3 | low | high | |
| 4 | moderate | low | |
| 5 | moderate | moderate | |
| 6 | moderate | high | |
| 7 | high | low | |
| 8 | high | moderate | |
| 9 | high | high | |

In Table 4, Antecedent 1 is the signal strength (x₃) of the current BS (BS1), Antecedent 2 is the signal strength (x₄) of the target BS (BS2) and Consequent is the possibility of handover (i.e., from BS1 to BS2). The experts were asked to fill in the blank for the Consequent using one of three linguistic labels (low, moderate, and high). The experts were given a randomized version of the nine questions shown in Table 4.

TABLE 4
Questions for handover in mobile multimedia cellular networks.

| Question | Signal Strength | Signal Strength | possibility of |
|---|---|---|---|
| Number | of BS1 | of BS2 | handover |
| 10 | low | low | |
| 11 | low | moderate | |
| 12 | low | high | |
| 13 | moderate | low | |
| 14 | moderate | moderate | |
| 15 | moderate | high | |
| 16 | high | low | |
| 17 | high | moderate | |
| 18 | high | high | |

Twenty respondents completed the survey, and their results are shown in Tables 5 and 6 below. In Table 5, the entries in the second through fourth columns correspond to the weights w^{l}₁, w^{l}₂, and w^{l}₃, described later, respectively.

TABLE 5
Histograms of expert responses about handover
based on bandwidth utilization.

| Rule Number (1) | low | moderate | high | c^{l} _{avg} |
|---|---|---|---|---|
| 1 | 13 | 7 | 0 | 3.0079 |
| 2 | 17 | 3 | 0 | 2.3362 |
| 3 | 20 | 0 | 0 | 1.8324 |
| 4 | 3 | 11 | 6 | 5.6277 |
| 5 | 5 | 12 | 3 | 4.8216 |
| 6 | 14 | 6 | 0 | 2.8400 |
| 7 | 0 | 0 | 20 | 8.3259 |
| 8 | 0 | 13 | 7 | 6.2882 |
| 9 | 14 | 6 | 0 | 2.8400 |

In Table 6, the entries in the second through fourth columns correspond to the weights w^{k}₁, w^{k}₂, and w^{k}₃, described later, respectively.

TABLE 6
Histograms of expert responses about handover
based on signal strengths.

| Rule Number (1) | low | moderate | high | c^{k} _{avg} |
|---|---|---|---|---|
| 10 | 15 | 5 | 0 | 2.6721 |
| 11 | 2 | 13 | 5 | 5.6389 |
| 12 | 0 | 3 | 17 | 7.8556 |
| 13 | 16 | 4 | 0 | 2.5041 |
| 14 | 13 | 7 | 0 | 3.0079 |
| 15 | 0 | 14 | 6 | 6.1315 |
| 16 | 20 | 0 | 0 | 1.8324 |
| 17 | 15 | 5 | 0 | 2.6721 |
| 18 | 3 | 17 | 0 | 4.6873 |

Knowledge Processing and Handover Decision Surface

In the approach to forming a rule base for the rules set 304, according to the present invention, a single consequent is used for each rule. To do this, centroids of all the responses for each rule were averaged and the average was used in place of the rule consequent centroid. Doing this leads to rules that have the following form:

R^{l}: IF the bandwidth utilization of cell1 (x₁) is F^{l}₁ and the bandwidth utilization of cell2 (x₂) is F^{l}₂, THEN the handover possibility (y) is c^{l}_{avg}.

where l=1, 2, . . . , 9, and,

R^{k}: IF the signal level of BS1 (x₃) is F^{k}₃ and the signal level of BS2 (x₄) is F^{k}₄, THEN the handover possibility (v) is c^{k}_{avg}.

where k=10, 11, . . . , 18.

In the above rules c^{l}_{avg} is defined as:

$${c}_{avg}^{l} = \frac{{\sum }_{i = 1}^{3} {w}_{i}^{l} {c}^{i}}{{\sum }_{i = 1}^{3} {w}_{i}^{l}} \qquad ( 3 )$$

where w^{l}ᵢ is the number of people choosing linguistic label i for the consequent of rule l (i=1, . . . , 3; l=1, . . . , 9) (see Table 5 above); and, cⁱ is the centroid of the ith consequent set (i=1, 2, 3). The centroids of the three fuzzy sets depicted in FIG. 4 are c¹=1.8324, c²=5.1911 and c³=8.3259. To illustrate the use of equation (3), note, for example, that:

$${c}_{avg}^{5} = \frac{{5}_{c}^{1} + {12}_{c}^{2} + {3}_{c}^{3}}{5 + 12 + 3} = 4.8216 \qquad ( 4 )$$

All nine c^{l}_{avg} values are listed in Table 5 above. In a similar manner, the values c^{k}_{avg} may be computed and all nine c^{k}_{avg} values are listed in Table 6 above. Accordingly, 18 rules, nine of them with antecedents “bandwidth utilizations” and nine of them with antecedents “signal levels” are determined. Then, for every input (x₁, x₂, x₃, x₄), the output y(x₁, x₂, x₃, x₄) is computed using:

$$\begin{matrix} y ( {x}_{1} , {x}_{2} , {x}_{3} , {x}_{4} ) = \frac{{\sum }_{l = 1}^{9} {μ}_{F1}^{l} ( {x}_{1} ) {μ}_{F2}^{l} ( {x}_{2} ) {c}_{avg}^{l} + {\sum }_{k = 10}^{18} {μ}_{F3}^{k} ( {x}_{3} ) {μ}_{F4}^{k} ( {x}_{4} ) {c}_{avg}^{k}}{{\sum }_{l = 1}^{9} {μ}_{F1}^{l} ( {x}_{1} ) {μ}_{F2}^{l} ( {x}_{2} ) + {\sum }_{k = 10}^{18} {μ}_{F3}^{k} ( {x}_{3} ) {μ}_{F4}^{k} ( {x}_{4} )} & ( 5 )\end{matrix}$$

By repeating these calculations for ∀xᵢε[0, 10], a hypersurface y(x₁, x₂, x₃, x₄) may be obtained. Since such a surface is a 4-D surface, it is difficult to be plot so as to be able to view the surface. Accordingly, if x₃=3 and x₄=6 and the two other antecedents, the bandwidth utilization of cell1 (x₁) and the bandwidth utilization of cell2 (x₂) are variables, for every input (x₁, x₂, 3, 6), the output is computed using:

$$y ( {x}_{1} , {x}_{2} , 3 , 6 ) = \frac{{\sum }_{l = 1}^{9} {μ}_{F1}^{l} ( {x}_{1} ) {μ}_{F2}^{l} ( {x}_{2} ) {c}_{avg}^{l} + {\sum }_{k = 10}^{18} {μ}_{F3}^{k} ( 3 ) {μ}_{F4}^{k} ( 6 ) {c}_{avg}^{k}}{{\sum }_{l = 1}^{9} {μ}_{F1}^{l} ( {x}_{1} ) {μ}_{F2}^{l} ( {x}_{2} ) + {\sum }_{k = 10}^{18} {μ}_{F3}^{k} ( 3 ) {μ}_{F4}^{k} ( 6 )} \qquad ( 6 )$$

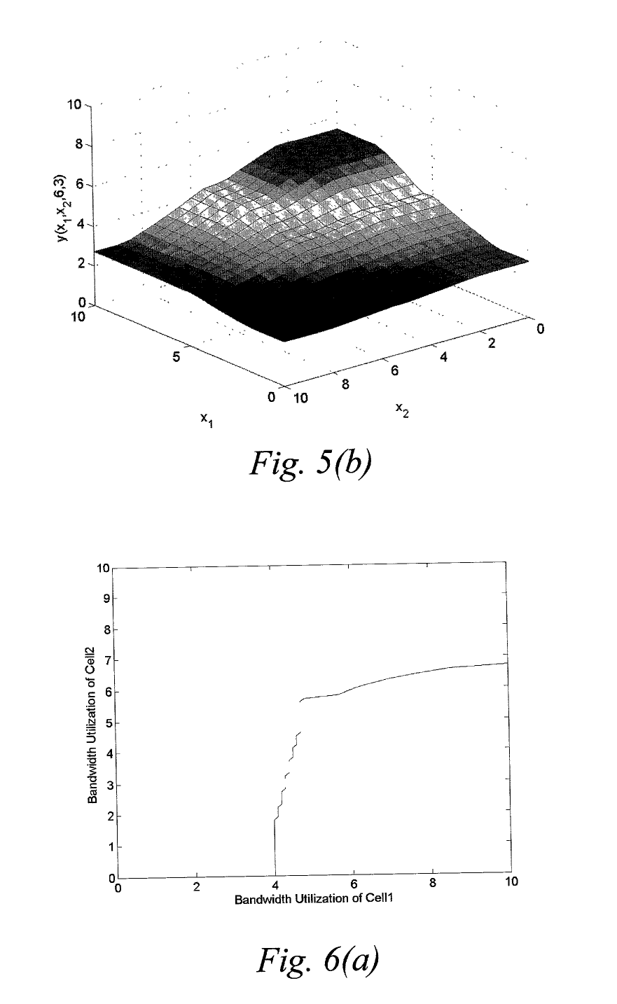

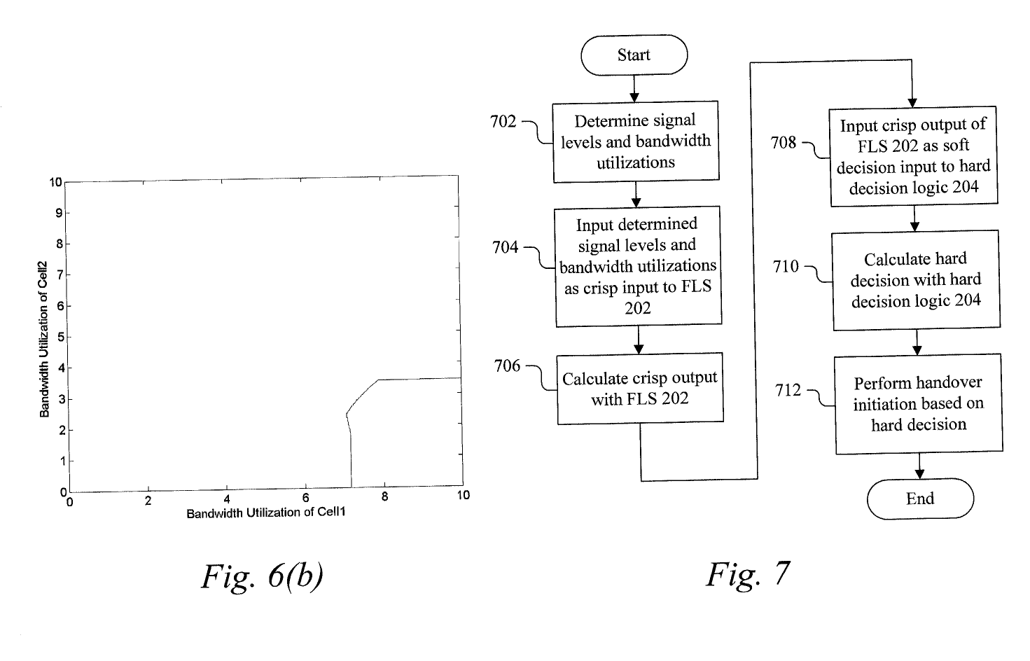

By repeating these calculations for ∀x₁ε[0, 10] and ∀x₂ε[0, 10], a hypersurface y(x₁, x₂, 3, 6) may be obtained and is plotted in FIG. 5(a). If the handover decision was made just based on the signal strength from BS1 (x₃) and BS2 (x₄), then the handover should be initiated because x₃<<x₄ (i.e., the signal strength from BS1 is much lower than that from BS2). But if the bandwidth utilization is included, decisions are made based on FIG. 5(a), handover is initiated if y(x₁, x₂, 3, 6)>5 and the link is maintained (i.e., no handover) if y(x₁, x₂, 3, 6)<5, a decision boundary may be obtained, which is plotted in FIG. 6(a). From FIG. 6(a), it is seen that the handover decision also depends on x₁ and x₂.

In contrast, if x₃=6 and x₄=3, and the two other antecedents x₁ and x₂ are variables, a hypersurface y(x₁, x₂, 6, 3) may be obtained, as plotted in FIG. 6(b). If the handover decision was made just based on the signal strength from BS1 (x₃) and BS2 (x₄), then the link should be maintained (i.e., no handover) because x₃>>x₄ (i.e., the signal strength from BS1 is much higher than that from BS2). But if the bandwidth utilization is included, decisions are made based on FIG. 6(b), handover is initiated if y(x₁, x₂, 6, 3)>5 and the link is maintained (i.e., no handover) if y(x₁, x₂, 6, 3)<5, a decision boundary may be obtained, which is plotted in FIG. 6(b).

From FIG. 6(b), it is seen that the handover decision also depends on x₁ and x₂. Comparing the decision boundaries in FIGS. 6(a) and 6(b), it is seen that the handover decision in FIG. 6(b) is very strict as compared to the handover decision in FIG. 6(a) because the signal strength from BS1 is much higher than that from BS2 in FIG. 6(a).

Handover initiation is a binary decision problem (i.e., a yes or no problem), which can be made by the hard decision logic 204, for example, based on the soft handover decision from the FLS 202 and QoS requirements of multimedia service [20] priority. For a higher priority service, such as real-time voice and video/audio, a lower threshold can be used in the hard decision logic 204. In contrast, for a lower priority service, such as non-real-time text data, a higher threshold can used in the hard decision logic 204 to minimize the number of handovers.

FIG. 7 is a flow chart illustrating the operation of the bandwidth utilization and signal strength-based handover initiation, according to the present invention. In FIG. 7, at step 702, signal strengths (x₃, x₄) at the devices 112-112″ from the cells 108-108″ and 116-116″ and bandwidth utilizations (x₁, x₂) in the cells 108-108″ and 116-116″ are determined. At step 704, the FLS 202 receives as a crisp input the determined signal strengths bandwidth utilizations (x₁, x₂, x₃, x₄). At step 706, the FLS 202 generates, as a crisp output thereof, a handover initiation soft decision based on the received crisp input. At step 708, the handover initiation soft decision is input to the hard decision logic 204.

At step 710, the hard decision logic 204 generates a handover initiation hard decision based on the handover initiation soft decision received from the FLS 202. At step 712, the control centers 106-106″ perform handover initiation based on the handover initiation hard decision received from the hard decision logic 204 and, for example, QoS requirements of multimedia service, completing the handover initiation process.

The present invention stores information relating to various processes described herein. This information is stored in one or more memories, such as a hard disk, optical disk, magneto-optical disk, RAM, etc. One or more databases, such as the databases within the devices 102-102″, 118-118″, 110-110″, 114-114″ and 112-112″ of the systems 100-100″, etc., may store the information used to implement the present invention. The databases are organized using data structures (e.g., records, tables, arrays, fields, graphs, trees, and/or lists) contained in one or more memories, such as the memories listed above or any of the storage devices listed below in the discussion of FIG. 8, for example.

The previously described processes include appropriate data structures for storing data collected and/or generated by the processes of the systems 100-100′of FIG. 1 in one or more databases thereof. Such data structures accordingly will includes fields for storing such collected and/or generated data. In a database management system, data is stored in one or more data containers, each container contains records, and the data within each record is organized into one or more fields. In relational database systems, the data containers are referred to as tables, the records are referred to as rows, and the fields are referred to as columns. In object-oriented databases, the data containers are referred to as object classes, the records are referred to as objects and the fields are referred to as attributes. Other database architectures may use other terminology. Systems that implement the present invention are not limited to any particular type of data container or database architecture. However, for the purpose of explanation, the terminology and examples used herein shall be that typically associated with relational databases. Thus, the terms “table,” “row,” and “column” shall be used herein to refer respectively to the data container, record, and field.

The present invention (e.g., as described with respect to FIGS. 1-7) may be implemented by the preparation of application-specific integrated circuits or by interconnecting an appropriate network of conventional component circuits, as will be appreciated by those skilled in the electrical art(s). In addition, all or a portion of the invention (e.g., as described with respect to FIGS. 1-7) may be conveniently implemented using one or more conventional general purpose computers, microprocessors, digital signal processors, micro-controllers, etc., programmed according to the teachings of the present invention (e.g., using the computer system of FIG. 8), as will be appreciated by those skilled in the computer and software art(s). Appropriate software can be readily prepared by programmers of ordinary skill based on the teachings of the present disclosure, as will be appreciated by those skilled in the software art. Further, the present invention may be implemented on the World Wide Web (e.g., using the computer system of FIG. 8).

FIG. 8 illustrates a computer system 801 upon which the present invention (e.g., the devices 102-102″, 118-118″, 110-110″, 114-114″ and 112-112″ of the systems 100-100″, etc.) can be implemented. The present invention may be implemented on a single such computer system, or a collection of multiple such computer systems. The computer system 801 includes a bus 802 or other communication mechanism for communicating information, and a processor 803 coupled to the bus 802 for processing the information. The computer system 801 also includes a main memory 804, such as a random access memory (RAM), other dynamic storage device (e.g., dynamic RAM (DRAM), static RAM (SRAM), synchronous DRAM (SDRAM)), etc., coupled to the bus 802 for storing information and instructions to be executed by the processor 803. In addition, the main memory 804 can also be used for storing temporary variables or other intermediate information during the execution of instructions by the processor 803. The computer system 801 further includes a read only memory (ROM) 805 or other static storage device (e.g., programmable ROM (PROM), erasable PROM (EPROM), electrically erasable PROM (EEPROM), etc.) coupled to the bus 802 for storing static information and instructions.

The computer system 801 also includes a disk controller 806 coupled to the bus 802 to control one or more storage devices for storing information and instructions, such as a magnetic hard disk 807, and a removable media drive 808 (e.g., floppy disk drive, read-only compact disc drive, read/write compact disc drive, compact disc jukebox, tape drive, and removable magneto-optical drive). The storage devices may be added to the computer system 801 using an appropriate device interface (e.g., small computer system interface (SCSI), integrated device electronics (IDE), enhanced-IDE (E-IDE), direct memory access (DMA), or ultra-DMA).

The computer system 801 may also include special purpose logic devices 818, such as application specific integrated circuits (ASICs), full custom chips, configurable logic devices (e.g., simple programmable logic devices (SPLDs), complex programmable logic devices (CPLDs), field programmable gate arrays (FPGAs), etc.), etc., for performing special processing functions, such as signal processing, image processing, speech processing, voice recognition, infrared (IR) data communications, satellite communications transceiver functions, the handover initiation device 118 functions, etc.

The computer system 801 may also include a display controller 809 coupled to the bus 802 to control a display 810, such as a cathode ray tube (CRT), liquid crystal display (LCD), active matrix display, plasma display, touch display, etc., for displaying or conveying information to a computer user. The computer system includes input devices, such as a keyboard 811 including alphanumeric and other keys and a pointing device 812, for interacting with a computer user and providing information to the processor 803. The pointing device 812, for example, may be a mouse, a trackball, a pointing stick, etc., or voice recognition processor, etc., for communicating direction information and command selections to the processor 803 and for controlling cursor movement on the display 810. In addition, a printer may provide printed listings of the data structures/information of the system shown in FIGS. 1-8, or any other data stored and/or generated by the computer system 801.

The computer system 801 performs a portion or all of the processing steps of the invention in response to the processor 803 executing one or more sequences of one or more instructions contained in a memory, such as the main memory 804. Such instructions may be read into the main memory 804 from another computer readable medium, such as a hard disk 807 or a removable media drive 808. Execution of the arrangement of instructions contained in the main memory 804 causes the processor 803 to perform the process steps described herein. One or more processors in a multi-processing arrangement may also be employed to execute the sequences of instructions contained in main memory 804. In alternative embodiments, hard-wired circuitry may be used in place of or in combination with software instructions. Thus, embodiments are not limited to any specific combination of hardware circuitry and software.

Stored on any one or on a combination of computer readable media, the present invention includes software for controlling the computer system 801, for driving a device or devices for implementing the invention, and for enabling the computer system 801 to interact with a human user (e.g., users of the systems 100-100″ of FIG. 1, etc.). Such software may include, but is not limited to, device drivers, operating systems, development tools, and applications software. Such computer readable media farther includes the computer program product of the present invention for performing all or a portion (if processing is distributed) of the processing performed in implementing the invention. Computer code devices of the present invention may be any interpretable or executable code mechanism, including but not limited to scripts, interpretable programs, dynamic link libraries (DLLs), Java classes and applets, complete executable programs, Common Object Request Broker Architecture (CORBA) objects, etc. Moreover, parts of the processing of the present invention may be distributed for better performance, reliability, and/or cost.

The computer system 801 also includes a communication interface 813 coupled to the bus 802. The communication interface 813 provides a two-way data communication coupling to a network link 814 that is connected to, for example, a local area network (LAN) 815, or to another communications network 816 such as the Internet. For example, the communication interface 813 may be a digital subscriber line (DSL) card or modem, an integrated services digital network (ISDN) card, a cable modem, a telephone modem, etc., to provide a data communication connection to a corresponding type of telephone line. As another example, communication interface 813 may be a local area network (LAN) card (e.g., for Ethernet™, an Asynchronous Transfer Model (ATM) network, etc.), etc., to provide a data communication connection to a compatible LAN. Wireless links can also be implemented. In any such implementation, communication interface 813 sends and receives electrical, electromagnetic, or optical signals that carry digital data streams representing various types of information. Further, the communication interface 813 can include peripheral interface devices, such as a Universal Serial Bus (USB) interface, a PCMCIA (Personal Computer Memory Card International Association) interface, etc.

The network link 814 typically provides data communication through one or more networks to other data devices. For example, the network link 814 may provide a connection through local area network (LAN) 815 to a host computer 817, which has connectivity to a network 816 (e.g. a wide area network (WAN) or the global packet data communication network now commonly referred to as the “Internet”) or to data equipment operated by service provider. The local network 815 and network 816 both use electrical, electromagnetic, or optical signals to convey information and instructions. The signals through the various networks and the signals on network link 814 and through communication interface 813, which communicate digital data with computer system 801, are exemplary forms of carrier waves bearing the information and instructions.

The computer system 801 can send messages and receive data, including program code, through the network(s), network link 814, and communication interface 813. In the Internet example, a server (not shown) might transmit requested code belonging to an application program for implementing an embodiment of the present invention through the network 816, LAN 815 and communication interface 813. The processor 803 may execute the transmitted code while being received and/or store the code in storage devices 807 or 808, or other non-volatile storage for later execution. In this manner, computer system 801 may obtain application code in the form of a carrier wave. With the system of FIG. 8, the present invention may be implemented on the Internet as a Web Server 801 performing one or more of the processes according to the present invention for one or more computers coupled to the Web server 801 through the network 816 coupled to the network link 814.

The term “computer readable medium” as used herein refers to any medium that participates in providing instructions to the processor 803 for execution. Such a medium may take many forms, including but not limited to, non-volatile media, volatile media, transmission media, etc. Non-volatile media include, for example, optical or magnetic disks, magneto-optical disks, etc., such as the hard disk 807 or the removable media drive 808. Volatile media include dynamic memory, etc., such as the main memory 804. Transmission media include coaxial cables, copper wire, fiber optics, including the wires that make up the bus 802. Transmission media can also take the form of acoustic, optical, or electromagnetic waves, such as those generated during radio frequency (RF) and infrared (IR) data communications. As stated above, the computer system 801 includes at least one computer readable medium or memory for holding instructions programmed according to the teachings of the invention and for containing data structures, tables, records, or other data described herein. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer connected to either of networks 815 and 816. In such a scenario, the remote computer loads the instructions into main memory and sends the instructions, for example, over a telephone line using a modem. A modem of a local computer system receives the data on the telephone line and uses an infrared transmitter to convert the data to an infrared signal and transmit the infrared signal to a portable computing device, such as a personal digital assistant (PDA), a laptop, an Internet appliance, etc. An infrared detector on the portable computing device receives the information and instructions borne by the infrared signal and places the data on a bus. The bus conveys the data to main memory, from which a processor retrieves and executes the instructions. The instructions received by main memory may optionally be stored on storage device either before or after execution by processor.

Recapitulating, most existing work on handover for wireless communications networks, such as mobile cellular networks, etc., is based on the assumption that the network traffic is uniformly-loaded for every cell (i.e., all cells in the network are equally loaded). In the present invention, a handover initiation scheme using fuzzy logic system (FLS) 202, for example, for non-uniformly-loaded wireless communications networks, such as mobile cellular networks, etc., is employed. Bandwidth utilization (e.g., of 2 cells) and signal strength (e.g., of 2 base stations) is combined into the handover decision making process. The linguistic knowledge of handover based on bandwidth utilization and signal strength is obtained from a group of network experts. The FLS 202 rules 304 are set up based on such linguistic knowledge and the number of rules 304 is reduced from 81 to 18 using union-rule configuration (URC). The output of the FLS 202 provides a four-dimensional (4-D) handover possibility surface, which then is used by the hard decision logic 204 to make hard handover decision based on, for example, a multimedia category and a desired QoS level.

The present invention includes, for example, the following features: (i) use of bandwidth utilizations in a handover decision; (ii) use of expertise from a plurality of experts in the rules 304 of the FLS 202, so that an acceptable soft handover surface or decision may be obtained from the FLS 202; and (iii) use of the soft handover decision and a priority of media service to make the hard handover decision.

While the present invention has been described in connection with a number of embodiments and implementations, the present invention is not so limited but rather covers various modifications and equivalent arrangements, which fall within the purview of the appended claims.

### List of References

[1] W. E. Combs, and J. E. Andrews, “Combinatorial rule explosion eliminated by a fuzzy rule configuration,” IEEE Trans Fuzzy System, vol. 6, no. 1, pp. 1-11, February 1998.

[2] I. W. Habib, R. Morris, H. Saito, and B. Pehrson, eds, Special Issue on Computational and Artificial Intelligence in High Speed Networks, IEEE J. Selected Areas in Communications, vol. 15, no. 2, February 1997.

[3] E. Gelenbe, I. W. Habib, S. Palazzo, and S. Douligeris, eds, Special Issue on Intelligent Techniques in High Speed Networks, IEEE J. Selected Areas in Communications, vol. 18, no. 2, February 2000.

[4] F. Graziosi, et al, “A multicell model of handover initiation in mobile cellular networks,” IEEE Trans. Vehicular Technology, vol. 48, no. 3, pp. 802-814, May 1999.

[5] J. Li, N. B. Shroff, and E. K. P. Chong, “Channel carrying: a novel handoff scheme for mobile cellular networks,” IEEE/ACM Trans. Networking, vol. 7, no. 1, pp. 38-50, February 1999..

[6] Q. Liang, and J. M. Mendel, “Connection admission control in ATM networks using survey-based type-2 fuzzy logic systems,” IEEE Trans. Systems, Man, and Cybernetics, Part C, vol. 30, no. 3, pp. 329-339, August 2000..

[7] E. H. Mamdani, “Applications of fuzzy logic to approximate reasoning using linguistic systems,” IEEE Trans. on Systems, Man, and Cybernetics, vol. 26, no. 12, pp. 1182-1191, 1977.

[8] Marimin, M. Umano, I. Hatono, and H. Tamura, “Linguistic labels for expressing fuzzy preference relations in fuzzy group decision making,” IEEE Trans. Systems, Man, Cybernetics-Part B: Cybernetics, vol. 28, no. 2, pp. 205-218, April 1998.

[9] J. M. Mendel, “Fuzzy Logic Systems for Engineering: A Tutorial,” Proceedings of the IEEE, vol. 83, no. 3, pp. 345-377, March 1995.

[10] J. M. Mendel, “Computing with words when words can mean different things to different people,:” Int'l. ICSC Congress on Computational Intelligence: Methods & Applications, Third Annual Symposium on Fuzzy Logic and Applications, Rochester, N.Y., Jun. 22-25, 1999.

[11] J. M. Mendel, “Uncertain Rule-Based Fuzzy Logic Systems,” Prentice-Hall, Upper Saddle River, N.J., 2001.

[12] S. Oh, and D. Tcha, “Prioritized channel assignment in a cellular radio networks,” IEEE Trans. Communications, vol. 40, pp. 1259-1269, July 1992.

[13] G. P. Pollini, “Trends in handover design,” IEEE Communications Magazine, pp. 82-90, March 1996.

[14] C. Purzynski, and S. Rappaport, “Multiple call handoff problem with queued handoffs and mixed platform types,” Proc. IEE Communications, vol. 142, pp. 31-39, February 1995.

[15] K. Shum, and C. W. Sung, “Fuzzy layer selection method in hierarchical cellualr systems,” IEEE Trans. Vehicular Technology, vol. 48, no. 6, pp. 1840-1849, November 1999.

[16] R. Vijayan, and J. M. Holtzman, “A model for analyzing handoff algorithm,” IEEE Trans. Vehi. Technol., vol. 42, pp. 351-356, August 1993.

[17] N. Zhang, and J. M. Holtzman, “Analysis of handoff algorithms using both absolute and relative measurements,” IEEE Trans. Vehi. Technol., vol. 45, pp. 174-179, February 1996.

[18] A network technology, for both local and wide area networks (LANs and WANs), that supports real-time voice and video as well as data. The topology uses switches that establish a logical circuit from end to end, which guarantees quality of service (QoS). However, unlike telephone switches that dedicate circuits end to end, unused bandwidth in ATM's logical circuits can be appropriated when needed. For example, idle bandwidth in a videoconference circuit can be used to transfer data.

[19] The ability to define a level of performance in a data communications system and mechanisms in the network software that make the actual determination of which packets have priority. For example, ATM networks specify modes of service that ensure optimum performance for traffic such as real-time voice and video.

[20] Class of Service (CoS) refers to feature sets, or groups of services, that are assigned to users based on company policy. If a feature set includes priority transmission, then CoS typically is implemented in QoS functions within the routers and switches in the network.

[21] See, e.g., “Cellular Communications” tutorial available on the World Wide Web at<www.iec.org/online/tutorials/cell_comm/>.

[22] An operations center that connects a landline PSTN system to a mobile phone system. It is also responsible for compiling call information for billing and handing off calls (i.e., handover) from one cell to another.

What is claimed is:

1. A method for bandwidth utilization and signal strength-based handover initiation in a wireless communications network, comprising:
determining signal strengths received at a mobile wireless device from a present and a target base station;
determining bandwidth utilizations at said present and said target base stations; and
performing handover initiation of said mobile device based on said determined signal strengths and said determined bandwidth utilizations.

2. The method of claim 1, wherein said step of performing said handover initiation comprises using a fuzzy logic system to generate a soft handover decision based on said determined signal strengths and said determined bandwidth utilizations.

3. The method of claim 2, wherein said step of performing said handover initiation comprises generating a hard handover decision based on said soft handover decision.

4. The method of claim 3, wherein said step of generating said hard handover decision comprises generating said hard handover decision based on a desired quality of service for said mobile device.

5. The method of claim 3, wherein said step of generating said hard handover decision comprises generating said hard handover decision based on a multimedia category of service provided for said mobile device.

6. The method of claim 2, wherein said step of using said fuzzy logic system comprises determining rules for said fuzzy logic system based on expertise of one or more experts.

7. The method of claim 6, wherein said step of determining said rules comprises determining a rule including three fuzzy subsets, four antecedents and a consequent.

8. The method of claim 7, further comprising:
configuring said three fuzzy subsets to include low, moderate and high linguistic labels;
configuring said four antecedents to include said determined signal strengths and said determined bandwidth utilizations; and
configuring said consequent as a possibility of handover including low, moderate and high linguistic labels.

9. The method of claim 6, wherein said step of determining said rules comprises determining two sets of rules, each set of rules including three fuzzy subsets, two antecedents and a consequent.

10. The method of claim 9, further comprising:
configuring said three fuzzy subsets to include low, moderate and high linguistic labels;
configuring said two antecedents of one of said two sets of rules to include said determined signal strengths;
configuring said two antecedents of the other one of said two sets of rules to include said determined bandwidth utilizations; and
configuring said consequent as a possibility of handover including low, moderate and high linguistic labels.

11. The method of claim 1, further comprising employing said handover initiation method in one of a cellular communications system, a satellite communications system and wireless local area network communications system.

12. A computer-readable medium carrying one or more sequences of one or more instructions for bandwidth utilization and signal strength-based handover initiation, the one or more sequences of one or more instructions including instructions which, when executed by one or more processors, cause the one or more processors to perform the steps recited in any one of claims 1-11.

13. A wireless communications system configured to include bandwidth utilization and signal strength-based handover initiation, comprising:
a control station configured to determine signal strengths received at a mobile wireless device from a present and a target base station;
said control station configured to determine bandwidth utilizations at said present and said target base stations; and
said control station configured to perform handover initiation of said mobile device based on said determined signal strengths and said determined bandwidth utilizations.

14. The system of claim 13, wherein said control station includes a fuzzy logic system configured to generate a soft handover decision based on said determined signal strengths and said determined bandwidth utilizations.

15. The system of claim 13, wherein said control station includes hard decision logic configured to generate a hard handover decision based on said soft handover decision.

16. The system of claim 15, wherein said hard decision logic is configured to generate said hard handover decision based on a desired quality of service for said mobile device.

17. The system of claim 15, wherein said hard decision logic is configured to generate said hard handover decision based on a multimedia category of service provided for said mobile device.

18. The system of claim 14, wherein said fuzzy logic system is configured to include rules based on expertise of one or more experts.

19. The system of claim 18, wherein said rules include a rule including three fuzzy subsets, four antecedents and a consequent.

20. The system of claim 19, wherein said three fuzzy subsets to include low, moderate and high linguistic labels,
said four antecedents include said determined signal strengths and said determined bandwidth utilizations; and
said consequent comprises a possibility of handover including low, moderate and high linguistic labels.

21. The system of claim 18, wherein said fuzzy logic system is configured to include two sets of rules, each set of rules including three fuzzy subsets, two antecedents and a consequent.

22. The system of claim 21, wherein said three fuzzy subsets include low, moderate and high linguistic labels,
said two antecedents of one of said two sets of rules to include said determined signal strengths,
said two antecedents of the other one of said two sets of rules include said determined bandwidth utilizations, and
said consequent comprises a possibility of handover including low, moderate and high linguistic labels.

23. The system of claim 13, wherein said wireless communications system comprises one of a cellular communications system, a satellite communications system and wireless local area network communications system.

24. A wireless communications system for bandwidth utilization and signal strength-based handover initiation, comprising:
means for determining signal strengths received at a mobile wireless device from a present and a target base station;
means for determining bandwidth utilizations at said present and said target base stations; and
means for performing handover initiation of said mobile device based on said determined signal strengths and said determined bandwidth utilizations.

25. A wireless communications device configured perform bandwidth utilization and signal strength-based handover initiation, comprising:
said device configured to determine signal strengths received at a mobile wireless device from a present and a target base station;
said device configured to determine bandwidth utilizations at said present and said target base stations; and
said device configured to perform handover initiation of said mobile device based on said determined signal strengths and said determined bandwidth utilizations.

26. The device of claim 25, wherein said device includes a fuzzy logic system configured to generate a soft handover decision based on said determined signal strengths and said determined bandwidth utilizations.

27. The device of claim 25, wherein said device includes hard decision logic configured to generate a hard handover decision based on said soft handover decision.

28. The device of claim 27, wherein said hard decision logic is configured to generate said hard handover decision based on a desired quality of service for said mobile device.

29. The device of claim 27, wherein said hard decision logic is configured to generate said hard handover decision based on a multimedia category of service provided for said mobile device.

30. The device of claim 26, wherein said fuzzy logic system is configured to include rules based on expertise of one or more experts.

31. The device of claim 30, wherein said rules include a rule including three fuzzy subsets, four antecedents and a consequent.

32. The device of claim 31, wherein said three fuzzy subsets to include low, moderate and high linguistic labels,
said four antecedents include said determined signal strengths and said determined bandwidth utilizations; and
said consequent comprises a possibility of handover including low, moderate and high linguistic labels.

33. The device of claim 30, wherein said fuzzy logic system is configured to include two sets of rules, each set of rules including three fuzzy subsets, two antecedents and a consequent.

34. The device of claim 33, wherein said three fuzzy subsets include low, moderate and high linguistic labels,
said two antecedents of one of said two sets of rules to include said determined signal strengths,
said two antecedents of the other one of said two sets of rules include said determined bandwidth utilizations, and
said consequent comprises a possibility of handover including low, moderate and high linguistic labels.

35. The device of claim 25, wherein said device is included in wireless communications system comprising one of a cellular communications system, a satellite communications system and wireless local area network communications system.

36. A wireless communications apparatus for bandwidth utilization and signal strength-based handover initiation, comprising:
means for determining signal strengths received at a mobile wireless device from a present and a target base station;
means for determining bandwidth utilizations at said present and said target base stations; and
means for performing handover initiation of said mobile device based on said determined signal strengths and said determined bandwidth utilizations.
